(19) United States
(12) Patent Application Publication
(10) Pub. No.: US 2024/0306662 A1
(43) Pub. Date: Sep. 19, 2024

(54) TOASTER DEVICE FOR MAKING COTTON CANDY AND STEAM HUMIDIFYING TYPE COTTON CANDY MACHINE

(71) Applicant: GUANGZHOU SUNZEE INTELLIGENT TECHNOLOGY CO., LTD, Guangzhou, Guangdong (CN)

(72) Inventor: Fangpin ZHU, Guangzhou (CN)

(21) Appl. No.: 18/027,601

(22) PCT Filed: Aug. 23, 2022
(86) PCT No.: PCT/CN2022/114242

§ 371 Date: Mar. 21, 2023

(30) Foreign Application Priority Data
Dec. 8, 2021 (CN) 202111494418.9

(51) Int. Cl. A23G 3/10; A23G 7/00; G01K 7/02

(52) U.S. Cl. CPC A23G 3/10; A23G 7/0031; G01K 7/02

(57) ABSTRACT

A toaster device includes a toaster body, a heating assembly, a machine base, a humidifying assembly, a motor assembly, and a feeding pipe. The toaster body is provided with a sugar generating chamber, the machine base includes a fixing base, a though hole, a bearing located in the though hole, and a support plate. The motor assembly includes a motor and a hollow rotating shaft, the rotating shaft sequentially extends through the fixing base and the heating assembly and is fixed to the toaster body, the motor drives the rotating shaft to drive the toaster body to rotate. The feeding pipe extends through the rotating shaft and is in communication with the sugar generating chamber. The humidifying assembly includes a water inlet, a water outlet, a water circuit, and a water delivery pipe, the water circuit is provided inside the fixing base and arranged around the though hole.

This application claims priority of Chinese Patent Application No. 202111494418.9, filed on Dec. 8, 2021, the content of which is hereby incorporated by reference in its entirety.

### TECHNICAL FIELD

The present disclosure relates to the technical field of cotton candy equipment, in particular, the present disclosure relates to a toaster device for making cotton candy, and a steam humidifying type cotton candy machine having the toaster device.

### BACKGROUND

In a production process of cotton candy, humidity control is very important. When the humidity is high, the made cotton candy are easy to melt, and when the humidity is low, the made cotton candy are fluffy and dry, resulting in poor viscosity and difficult production. In cotton candy machines, a humidifier is generally used to adjust the humidity in the process of making cotton candy.

For the humidity problem when making cotton candy, the Chinese patent application CN112524726A discloses “a new toaster with integrated structure of humidifier”, including a fixing plate, a motor is fixed to a right end of a bottom of the fixing plate, an output end of the motor is provided with a driving pulley, a left side of the driving pulley is provided with a driven pulley, the driven pulley is connected to a rotating shaft by a bolt, the application makes the device not only able to intelligently monitor the toaster during use, and a temperature of the toaster itself is configured to spray water on the rotating toaster to generate water vapor, thereby increasing an air humidity around the toaster and effectively utilizing an excess energy of the toaster, and reducing costs and save equipment space, thereby reducing the temperature of the toaster, replacing a conventional way of manually humidifying with artificial sensation or using a humidifier, thereby improving work efficiency and prolonging a service life of the device, and the device the device has a simple structure and saves costs.” However, the technical solution of this patent application further has the following disadvantages:

1. Since the water vapor is generated by spraying water directly on the toaster, this method of water spraying does not enable all the water sprayed on the toaster to generate water vapor, so that a conversion of water into the water vapor to humidify the air has a low utilization rate, the water consumption is large, and more waste water is generated.

2. In winter, due to an excessive internal humidity and a high temperature operation of a toaster device, it is easy to cause a large amount of condensation inside a cotton candy machine.

3. When humidifying, a large amount of water is directly sprayed on the toaster device, which will cause the temperature of the toaster device to drop, which may make the temperature of the toaster device not reach a temperature of melting sugar, and part of sugar grains will not melt into syrup, or the toaster device takes a long time to return to an optimal heating temperature, which will affect a stability of cotton candy production or affect a quality of made cotton candy.

### SUMMARY

In order to overcome the problems in the related art, the present disclosure provides a toaster device for making cotton candy, and a steam humidifying type cotton candy machine having the toaster device. The cotton candy machine has a high utilization rate of water and will not affect a stability of cotton candy production, nor will it affect a quality of made cotton candy, and it will not cause condensation in the cotton candy machine in winter.

In order to achieve the above object, the present disclosure provides the following technical solutions:

A toaster device for making cotton candy, includes a toaster body, a heating assembly, a machine base, a humidifying assembly, a motor assembly, and a feeding pipe. The toaster body is provided with a sugar generating chamber, the heating assembly is provided blow the toaster body, the machine base includes a fixing base, a though hole, a bearing, and a support plate, the though hole penetrates through upper and lower sides of the fixing base, the bearing is located in the though hole, the motor assembly includes a motor and a hollow rotating shaft, the motor and the rotating shaft are provided on upper and lower sides of the support plate, respectively, the rotating shaft sequentially extends through the fixing base and the heating assembly, a top end of the rotating shaft is fixed to the toaster body, the motor is configured to drive the rotating shaft to drive the toaster body to rotate, the feeding pipe extends through the rotating shaft into the toaster body and is in communication with the sugar generating chamber, the humidifying assembly includes a water inlet, a water outlet, a water circuit, and a water delivery pipe, the water inlet and the water outlet are provided on the fixing base, the water circuit is provided inside the fixing base and arranged around the though hole, one end of the water circuit is in communication with the water inlet, the other end thereof is in communication with the water outlet, one end of the water delivery pipe is in communication with the water outlet, and the other end thereof is in communication with the sugar generating chamber through the feeding pipe.

Further, the humidifying assembly further includes a water storage chamber provided at a bottom of the sugar generating chamber, the water storage chamber is sleeved on the rotating shaft, and the water delivery pipe is in communication with the water storage chamber.

Further, the humidifying assembly further includes a water retaining element covering the water storage chamber, and the feeding pipe extends through the water retaining element and is in communication with the sugar generating chamber.

Further, the water retaining element is circumferentially provided with a plurality of water outlet holes extending through a thickness direction thereof, the water outlet holes are in communication with the water storage chamber and the sugar generating chamber.

In one of the embodiments, an inner side of the water retaining element is circumferentially provided with grooves and an engaging portion connected to edges of the grooves, an engaging groove is provided at a bottom of the water storage chamber, the engaging groove cooperates with the engaging portion to achieve a connection between the water retaining element and the water storage chamber.

In one of the embodiments, the water outlet hole is arranged in an outwardly inclined direction along a center of the water retaining element.

Further, the toaster device further includes a thermocouple, a collector ring, and a carbon brush, the machine base further includes a support post provided between the fixing base and the support plate to form an accommodating space, the collector ring, the carbon brush, and the thermocouple are provided in the accommodating space.

Further, the toaster device further includes a temperature measuring sensor provided at a bottom of the toaster body, or between the heating assembly and the toaster body.

Accordingly, the present disclosure further provides a steam humidifying type cotton candy machine, including a detecting unit, a sugar making chamber, a controller, and the above-mentioned toaster device for making cotton candy. The detecting unit is configured to detect a humidity in the sugar making chamber, the controller is electrically connected to the detecting unit and the toaster device respectively, the controller receives a humidity signal sent by the detecting unit and generates a corresponding control humidity instruction and output the instruction to the humidifying assembly of the toaster device, and the humidifying assembly is adjusted accordingly to adjust the humidity in the sugar making chamber.

Further, the cotton candy machine further includes a housing, a sugar taking space, a manipulator, and a stick dispensing device. The sugar making chamber is formed in the housing, the sugar taking space is provided on the housing, the controller and the toaster device are both provided in the housing, the manipulator and a stick dispensing device are both provided in the sugar making chamber, the manipulator is configured to grip a sugar stick in the stick dispensing device and wind sugar filament above the toaster device to make a cotton candy.

Compared with the prior art, the solution of the present disclosure has the following advantages:

In the humidifying assembly, after the water passing through the water inlet, the water circuit, and the water outlet sequentially absorbs the heat of the fixing base and the bearing, it enters the sugar generating chamber from the water delivery pipe to form water vapor due to heating. On this basis, the water that enters the sugar generating chamber needs to absorb less heat, that is, an energy consumption provided by the heating assembly needs to be reduced, so that the sugar generating chamber loses less heat and can quickly return to an optimum heating temperature without affecting the production of cotton candy.

At the same time, the water passing through the water delivery pipe is evenly sprinkled into the sugar generating chamber under the action of centrifugal force, which can fully absorb heat and convert it into water vapor with high efficiency, thereby improving the utilization rate of water and reducing water consumption, and produces almost no excess waste water.

In addition, the humidifying assembly absorbs the heat of the fixing base and the bearing, so that the fixing base and the bearing are not easily damaged by a high temperature working environment, thereby prolonging a service life of the bearing and thus prolonging a service life of the toaster device.

In addition, in the cotton candy machine, the humidified water directly enters the sugar making chamber, and the water vapor that is sprayed into the sugar making chamber to humidify the working environment is water vapor, the amount of water vapor is monitored by the detecting unit, which can avoid an occurrence of excessive moisture, and will not produce condensation in winter.

Additional aspects and advantages of the application will be set forth in part in the following description, and will become apparent from the description, or may be learned by practice of the application.

### BRIEF DESCRIPTION OF THE DRAWINGS

These and other features of the present invention will become readily apparent upon further review of the following specification and drawings.

FIG. 1 is a perspective view of a steam humidifying type cotton candy machine shown in an embodiment of the present disclosure.

FIG. 2 is a perspective view of a toaster device for making cotton candy shown in an embodiment of the present disclosure.

FIG. 3 is an exploded view of the toaster device for making cotton candy shown in an embodiment of the present disclosure.

FIG. 4 is a cross-sectional view of the toaster device for making cotton candy shown in an embodiment of the present disclosure.

FIG. 5 is an enlarged view of part A in FIG. 4.

FIG. 6 is perspective view of a fixing base of the toaster device for making cotton candy shown in an embodiment of the present disclosure.

FIG. 7 is a cross-sectional view of the toaster device for making cotton candy shown in an embodiment of the present disclosure.

FIG. 8 is a perspective view of a toaster body and a humidifying assembly (a part) in the toaster device for making cotton candy shown in an embodiment of the present disclosure.

FIG. 9 is a perspective view of a water retaining element in the toaster device for making cotton candy shown in an embodiment of the present disclosure.

### Reference Numbers

housing 100;
sugar making chamber 200;
controller 300;
toaster device 400:
toaster body 1: toaster base 11, recessed portion 111, blade 112, sugar generating
chamber 12, toaster cover 13, through hole 131, water retaining dish 132, water retaining plate 133;
heating assembly 2: electromagnetic induction coil 21;
machine base 3: fixing base 31, though hole 32, bearing 33, support plate 34, support post 35, collector ring 36, carbon brush 37;
humidifying assembly 4: water inlet 41, water outlet 42, water circuit 43, water delivery pipe 44, water storage chamber 45, engaging groove 451, water retaining element 46, water outlet hole 461, groove 462, engaging portion 463;
motor assembly 5: motor 51, rotating shaft 52, belt 53, driving pulley 54, driven pulley 55, protecting case 56;
feeding pipe 6: pipe seat 61, pipe clip 62;
gap 7;
water inlet pipe 8;
sugar taking space 500;
manipulator 600;
stick dispensing device 700.

### DETAILED DESCRIPTION OF THE EMBODIMENTS

Preferred embodiments of the present disclosure will be described in more detail below with reference to the accompanying drawings. Although preferred embodiments of the present disclosure are shown in the drawings, it should be understood that the present disclosure may be embodied in various forms and should not be limited to the embodiments set forth herein. Rather, these embodiments are provided so that this application will be thorough and complete, and will fully convey the scope of this application to those skilled in the art.

The terminology used in the present disclosure is for the purpose of describing particular embodiments only, and is not intended to limit the application. As used in the present disclosure and the appended claims, the singular forms “a”, “the”, and “the” are intended to include the plural forms as well, unless the context clearly dictates otherwise. It should further be understood that the term “and/or” as used herein refers to and includes any and all possible combinations of one or more of the associated listed items

It should be understood that although the terms “first”, “second”, “third” and so on may be used in the present disclosure to describe various information, such information should not be limited to these terms. These terms are only used to distinguish information of the same type from one another. For example, without departing from the scope of the present disclosure, first information may further be called second information, and similarly, second information may further be called first information. Thus, a feature defined as “first” and “second” may explicitly or implicitly include one or more of these features. In the description of the present disclosure, “plurality” means two or more, unless otherwise specifically defined.

The technical solutions of the embodiments of the present disclosure will be described in detail below with reference to the accompanying drawings.

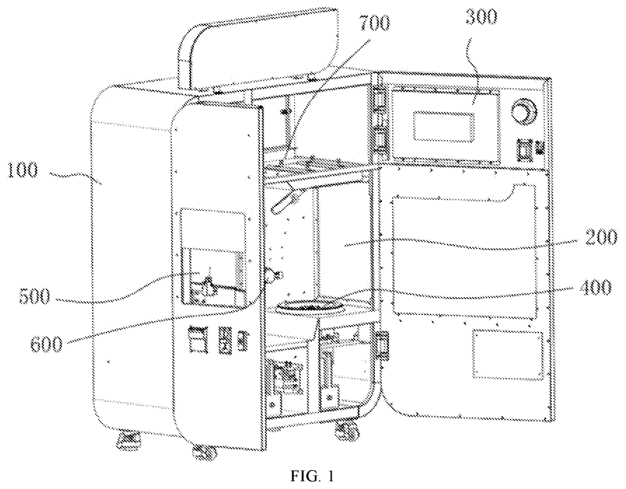

As shown in FIG. 1, the present disclosure provides a steam humidifying type cotton candy machine. The cotton candy machine includes a detecting unit (not shown), a sugar making chamber 200, a controller 300, and a toaster device 400. Both the detecting unit and the toaster device 400 are provided in the sugar making chamber 200, the toaster device 400 is mainly configured to provide sugar filament and steam for making cotton candy, and the steam provided by it can further keep a humidity in the sugar making chamber 200 stable. The detecting unit can detect the humidity in the sugar making chamber 200, the controller 300 is electrically connected to the detecting unit and the toaster device 400, respectively.

A working principle of the cotton candy machine is: when the detecting unit detects that the humidity in the sugar making chamber 200 is lower than a humidity required for making cotton candy, the detecting unit generates a corresponding signal and feeds it back to the controller 300. After receiving the humidity signal sent by the detecting unit, the controller 300 generates a corresponding control humidity instruction and outputs it to the toaster device 400. The toaster device 400 heats a water located therein to form water vapor. As affected by a centrifugal force generated by the toaster device 400, the water vapor enters the sugar making chamber 200 from the toaster device 400, thus gradually increasing the humidity in the sugar making chamber 200, and simultaneously humidifying the cotton candy in production, making the cotton candy denser and more saturated, enhancing its taste. On the other hand, since the amount of water vapor is generated under the monitoring of the detecting unit, excessive humidity will not occur, and condensation will not occur in winter.

In addition, the cotton candy machine further includes a housing 100, a sugar taking space 500, a manipulator 600, and a stick dispensing device 700. Specifically, the sugar making chamber 200 and the controller 300 are provided in the housing 100, and as mentioned above, the detecting unit and the toaster device 400 are provided in the sugar making chamber 200, and the toaster device 400 is exposed in the sugar making chamber 200. The sugar taking space 500 is provided on a side of the housing 100 adjacent to the sugar making chamber 200, and the cotton candy made in the sugar making chamber 200 are transferred to the sugar taking space 500 to be obtained by consumers. In addition, the manipulator 600 and the stick dispensing device 700 are provided in the sugar making chamber 200. The stick dispensing device 700 provides sugar sticks for the making of cotton candy, the manipulator 600 grips the sugar sticks, and winds sugar filaments on the toaster device 400 to make the cotton candy. The manipulator 600 further transfers the finished cotton candy to the sugar taking space 500 to be obtained.

In a preferred embodiment, a space is further provided above the sugar making chamber 200 for configuring the stick dispensing device 700. Meanwhile, an accommodating space is provided under the sugar making chamber 200, the toaster device 400 is provided in the accommodating space and partially exposed to the sugar making chamber 200. The above-mentioned accommodating space is further provided with components such as a water tank and a sugar tank, which do not affect an appearance and are convenient for replacement and use. In some embodiments, a humidity circulation system is further provided in the sugar making chamber 200, and the humidity circulation system is connected to the toaster device 400, so that a working environment of the entire cotton candy is in a state of internal circulation, which prevents pollution from an external environment and is clean and hygienic.

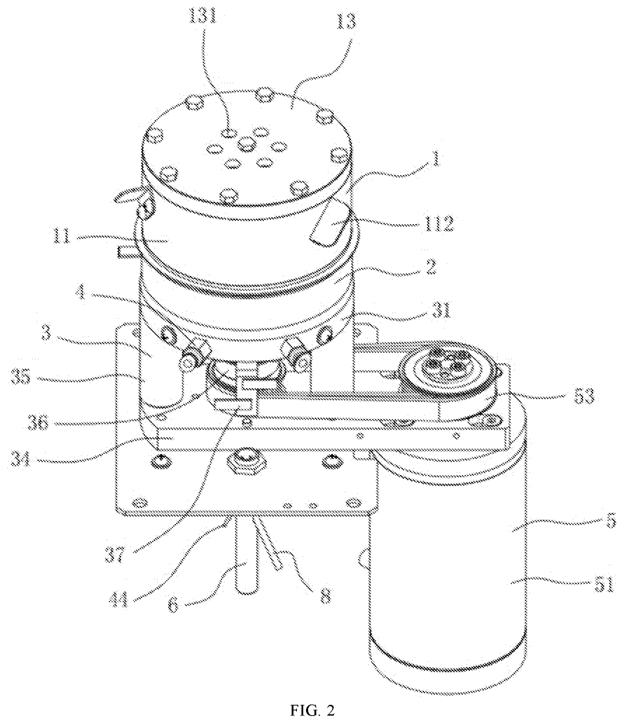

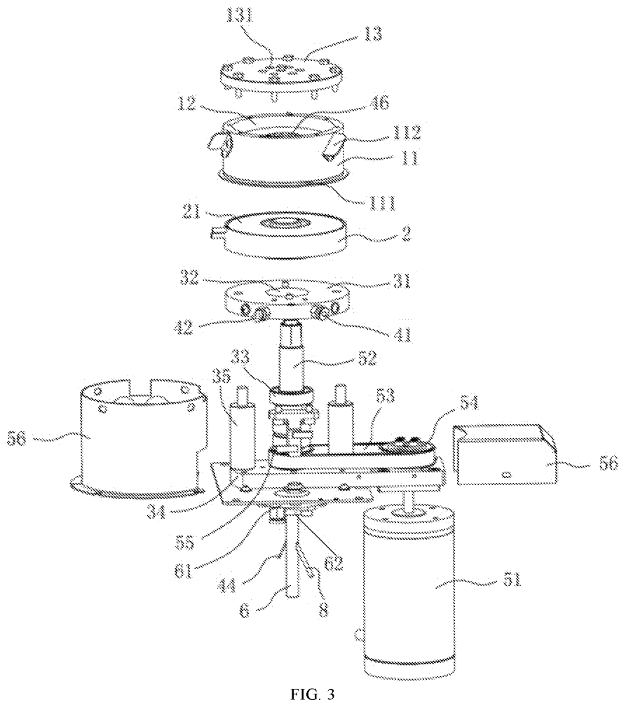

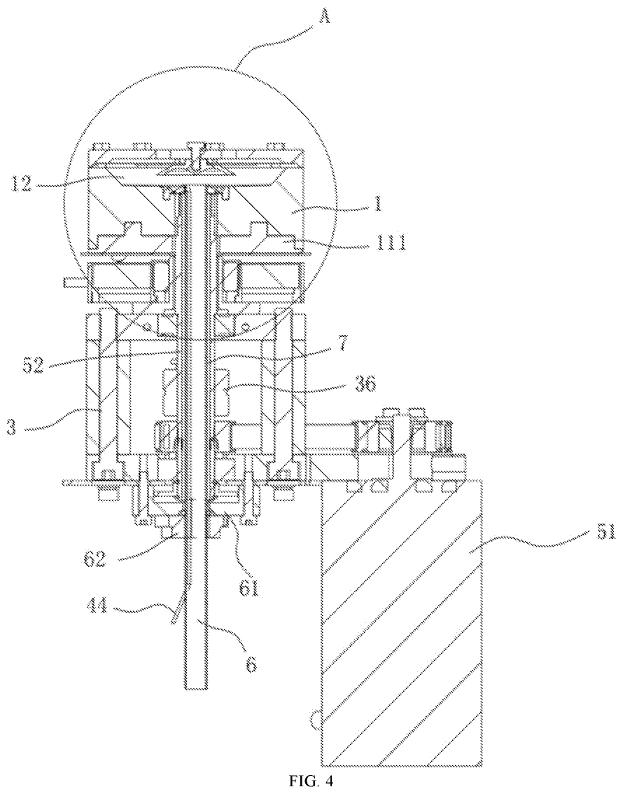

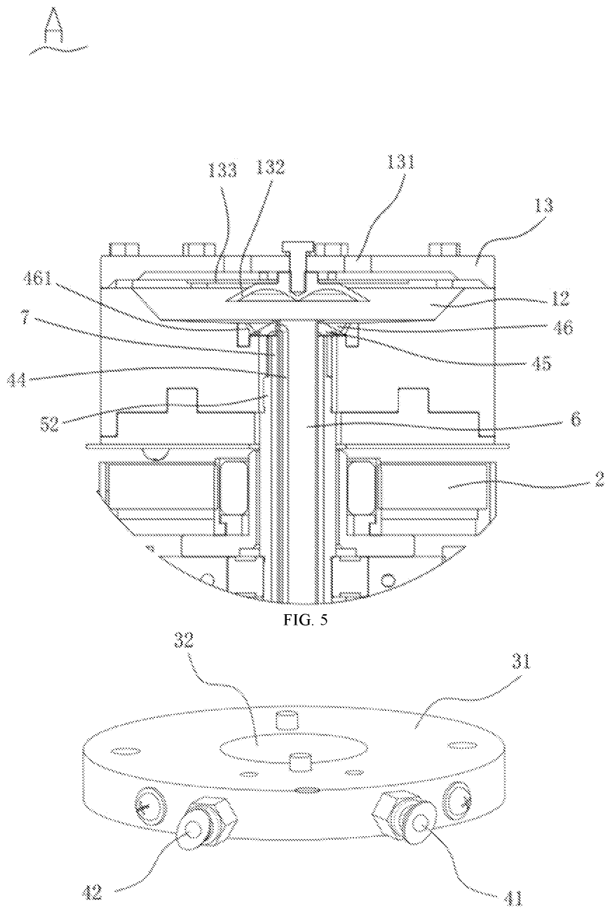

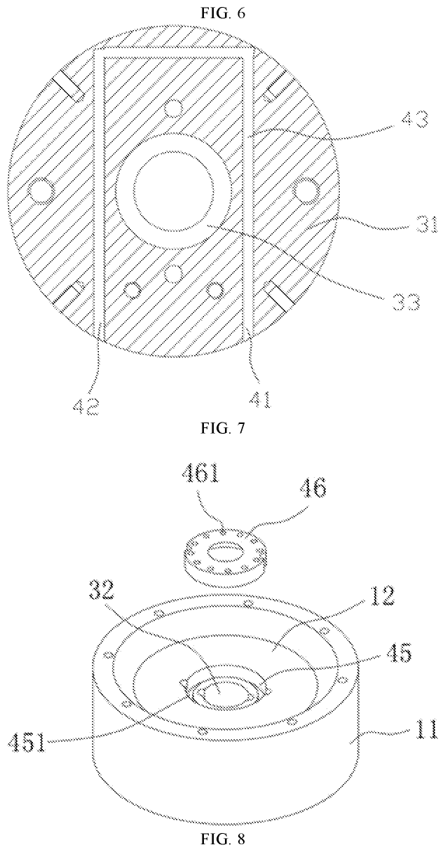

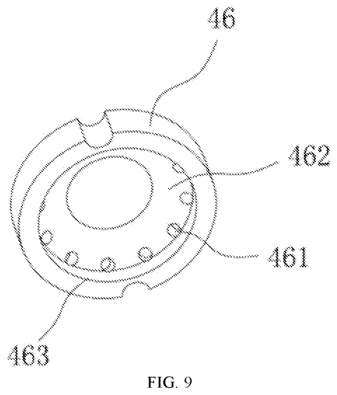

Accordingly, in order to achieve the above-mentioned function of the cotton candy machine in making high quality cotton candy while keeping the humidity inside the sugar making chamber 200 stable, the present disclosure further provides the toaster device 400 for making cotton candy. Referring to FIGS. 2 to 9, a specific structure and working principle of the toaster device 400 will be described in detail below.

The present disclosure provides the toaster device 400 for making cotton candy, which includes a toaster body 1, a heating assembly 2, a machine base 3, a humidifying assembly 4, a motor assembly 5, and a feeding pipe 6.

The heating assembly 2 is located under the toaster body 1, the machine base 3 is located under the heating assembly 2. The toaster body 1 is configured to make sugar filaments, which are thrown out and wound into cotton candy. The heating assembly 2 is configured to heat the toaster body 1, so that sugar grains in the toaster body 1 are turned into syrup and are thrown out to form sugar filaments. The machine base 3 is configured to support the heating assembly 2 and the toaster body 1, and fix the heating assembly 2 under the toaster body 1, so that the toaster body 1 can be heated effectively.

The machine base 3 is provided with the humidifying assembly 4 and the motor assembly 5. The humidifying assembly 4 is configured to humidify the toaster body 1, so that the entire sugar making chamber 200 is in an optimal humidity for processing cotton candy, and the produced cotton candy are dense and saturated, with stable and good quality. The motor assembly 5 is configured to drive the toaster body 1, which can enable the toaster body 1 to rotate at a high speed, thereby throwing out the syrup in the toaster body 1, and throwing out the sugar filament under an action of centrifugal force to the sugar making chamber 200, so that the manipulator 600 can hold the sugar stick and wind the sugar filament into various flower-shaped cotton candy.

Specifically, the toaster body 1 is provided with a toaster base 11 and a toaster cover 13. The toaster base 11 is concavely provided with a sugar generating chamber 12, and the toaster cover 13 is located above the sugar generating chamber 12 and covers the toaster base 11. The feeding pipe 6 is in communication with the sugar generating chamber 12, so that the feeding pipe 6 can send sugar grains into the sugar generating chamber 12. The heating assembly 2 is located under the toaster body 1, so that the heating assembly 2 can heat the sugar generating chamber 12 to melt the sugar grains into syrup. The sugar generating chamber 12 is provided with a tooth opening (not shown) in communication with the sugar making chamber 200, and the syrup is thrown out into the sugar making chamber 200 through the tooth opening. In a preferred embodiment, the tooth opening is located between the toaster cover 13 and the toaster base 11, and is provided around an edge of the toaster cover 13. When the toaster body 1 rotates at the high speed, under the action of centrifugal force, it is convenient to throw the syrup out of the tooth opening and form a uniform and delicate sugar filament.

Further, a plurality of through holes 131 are provided on the toaster cover 13, so as to keep the feeding pipe 6 ventilated and to balance an air pressure inside and outside the toaster device 400, so that a feeding direction is unified. A water retaining dish 132 is further provided below the through hole 131, which can prevent sugar grains in the feeding pipe 6 from being partially thrown out of the through hole 131 after entering the sugar generating chamber 12, blocking the through hole 131 or throwing out into the sugar making chamber 200 and winding on the cotton candy, thus affecting the quality and taste of the cotton candy. The water retaining dish 132 is located on an upper wall of the toaster cover 13 where the through hole 131 is located, a water retaining plate 133 is further provided between the water retaining dish 132 and the wall of the toaster. A gap is provided between the water retaining plate 133 and the through hole 131. Preferably, the water retaining dish 132 is a hollow conical truss, the water retaining dish 132 is located in a middle of the wall where it is located. The water retaining plate 133 is ring-shaped and formed on an outer periphery of the water retaining dish 132. The water retaining dish 132 can change a direction in which the sugar grains are fed into the feeding pipe 6, so that the sugar grains sent into the sugar generating chamber 12 collide with the water retaining dish 132 and sprinkle sugar evenly downwards. Moreover, when the feeding pipe 6 supplies water to clean the sugar generating chamber 12, the water retaining dish 132 can change a direction of water flow, the water flows downward and spin out at a high speed to achieve a good cleaning effect.

In addition, an outside of a bottom of the toaster base 11 is provided with a recessed portion 111, the heating assembly 2 is connected to the toaster body 1 through the recessed portion 111. Preferably, a plurality of blades 112 are provided on the outside of the toaster base 11, the plurality of blades 112 are evenly distributed along a circumference of the toaster base 11, which affects an airflow on the outside of the toaster body 1 when the toaster body 1 rotates at the high speed, so that the airflow is guided upward, and the sugar filament is blown to a same place, so as to prevent the sugar filament from flying randomly and facilitate the sugar stick to wrap around the sugar filament.

In a preferred embodiment, the heating assembly 2 is provided with an electromagnetic induction coil 21. Alternating current is supplied to the electromagnetic induction coil 21 to generate an alternating magnetic field, which generates heat when the alternating magnetic field passes through the toaster body 1, thereby achieving a rapid heating of the toaster body 1. Meanwhile, the heating assembly 2 is further provided with a temperature measuring sensor (not shown), the temperature measuring sensor is located in the recessed portion 111 of the toaster base 11, or between the heating assembly 2 and the toaster body 1. A temperature inside the toaster body 1 can be detected by the temperature measuring sensor in real time, and the controller 300 can adjust a heating power of the electromagnetic induction coil 21 according to the temperature fed back by the temperature measuring sensor, so that the temperature inside the toaster body 1 is controllable, thereby ensuring the quality of the made cotton candy. At the same time, the temperature measuring sensor further detects the temperature of the toaster body 1 in the humidification process in real time to ensure that the toaster body 1 has enough heat to heat the water. After the humidification is completed, the timely detection of the temperature sensor can avoid the problem that the temperature of the toaster body 1 is too high and the syrup in the sugar generating chamber 12 is scorched.

Preferably, the toaster body 1 is made of aluminum alloy material. The toaster body I can be heated up quickly by utilizing a thermal conductivity of the aluminum alloy material, that is, the sugar generating chamber 12 can be heated up quickly to the optimum heating temperature, so that the sugar grains melt into sugar syrup.

The machine base 3 includes a fixing base 31, a through hole 32, a bearing 33, and a support plate 34. The fixing base 31 is located under the heating assembly 2, upper and lower sides of the fixing base 31 are penetrated to form the through hole 32, and the bearing 33 is located in the through hole 32. Preferably, the through hole 32 is located in a middle of the fixing base 31.

The motor assembly 5 includes a motor 51 and a hollow rotating shaft 52, the motor 51 and the rotating shaft 52 are provided on upper and lower sides of the support plate 34, respectively. An end of the rotating shaft 52 is fixed on the support plate 34, and then sequentially extends through the fixing base 31 and the heating assembly 2. A top end of the rotating shaft 52 is fixed to the toaster body 1. Since the bearing 33 is located in the through hole 32, the bearing 33 can be sleeved on the rotating shaft 52. When the motor 51 drives the rotating shaft 52 to rotate, the toaster body I can be driven to rotate.

Specifically, a belt 53 is provided between the rotating shaft 52 and the motor 51 for transmission. The support plate 34 is provided with a motor adjusting hole (not shown), the motor 51 is bolted to a bottom surface of the support plate 34 through the motor adjusting hole. A driving shaft of the motor 51 extends through the motor adjusting hole. A driving pulley 54 is fixed above the supporting plate 34, the driving pulley 54 is sleeved on the drive shaft of the motor 51, and a driven pulley 55 is sleeved on the rotating shaft 52. The driving pulley 54 is linked to the driven pulley 55 through the belt 53. An axis distance between the driving pulley 54 and the driven pulley 55 is adjusted through the motor adjusting hole, that is, a tightness of the belt 53 is adjusted. With this kind of transmission mode, i.e., a rotation of the rotating shaft 52 is controlled by the motor 51, the transmission is stable and has high efficiency, which can effectively reduce a working noise of the toaster device 400.

In a preferred embodiment, in order to ensure that an assembly of the rotating shaft 52 is firmer and to ensure a stability of the toaster body 1 during rotation, a top of the fixing base 31 is provided with two bearings 33, and a bottom of the fixing base 31 is provided with two bearings 33, the rotating shaft 52 cooperates with inner rings of several bearings 33 to ensure the stability of the toaster body 1 during rotation.

Since the rotating shaft 52 is a hollow rotating shaft, the feeding pipe 6 can extend through the rotating shaft 52 and extend into the toaster body 1, so that the feeding pipe 6 can be in communication with the sugar generating chamber 12, so the sugar grains can enter the sugar generating chamber 12 through the feeding pipe 62.

Specifically, one end of the feeding pipe 6 extends into the sugar generating chamber 12, and the other end thereof extends out of the support plate 34 and is fixed to the support plate 34. A pipe base 61 is provided below the support plate 34 for fixing the feeding pipe 6. In addition, the pipe base 61 is further provided with a pipe clip 62 to further fix the feeding pipe 6 on the pipe base 61, so as to prevent the feeding pipe 6 from being affected by high-speed rotation and to avoid shaking, and prevent noise or wear of the rotating shaft 52 due to friction between the feeding tube 6 and the rotating shaft 52 52. A gap 7 is formed between the rotating shaft 52 and the feeding pipe 6. A waste water receiving plate is provided blow the gap 7, the waste water receiving plate is configured to receive the waste water flowing down from the sugar generating chamber 12. In addition, the sugar tank is provided in the accommodating space of the sugar making chamber 200, the sugar grains in the sugar tank are blown into the sugar generating chamber 12 from bottom to top in the feeding pipe 6 by an air pump. This feeding manner of the sugar is convenient for the feeding pipe 6 to evenly add sugar into the sugar generating chamber 12, and at the same time, the safety and stability of this operation mode are high, so that the structure of the toaster device 400 is optimized. The feeding pipe 6 directly extends into the rotating shaft 52 without increasing or destroying the structure of the toaster device 400, so that a performance of the toaster device 400 is more stable.

Further, a cleaning pipe (not shown) is further provided in the feeding pipe 6, and the cleaning pipe sprays a cleaning agent into the sugar generating chamber 12, so as to perform deep cleaning on the sugar generating chamber 12, thereby completing the cleaning of the toaster body 1, so that customers can enjoy fresh cotton candy, and can effectively reduce a risk of food safety. Correspondingly, a water inlet pipe 8 is further provided blow the feeding pipe 6, the water inlet pipe 8 is connected to the water tank. When cleaning is required, a water pump supplies the water in the water tank through the water inlet pipe 8 and the feeding pipe 6 into the sugar generating chamber 12, so as to rinse the sugar generating chamber 12 and complete the cleaning of the sugar generating chamber 12, so that no expired or deteriorated sour syrup will remain in the sugar generating chamber 12, the taste of the made cotton candy will be kept fresh, and the food safety of the cotton candy will be ensured.

The humidifying assembly 4 includes a water inlet 41, a water outlet 42, a water circuit 43, and a water delivery pipe 44. The water inlet 41 and the water outlet 42 are provided on the fixing base 31, preferably, the water inlet 41 and the water outlet 42 are both provided at an edge of the fixing base 31. The water circuit 43 is provided inside the fixing base 31 and arranged around the though hole 32. One end of the water circuit 43 is in communication with the water inlet 41, the other end thereof is in communication with the water outlet 42. One end of the water delivery pipe 44 is in communication with the water outlet 42, and the other end thereof extends into the toaster body 1 through the feeding pipe 6, so that the water pipe 44 is in communication with the sugar generating chamber 12. The water inlet 41 is connected to the water tank (not shown), and the water pump (not shown) adds the water in the water tank from the water inlet 41 into the water circuit 43, and the water flows out from the water outlet 42 and reaches the sugar generating chamber 12 through the water delivery pipe 44. In a preferred embodiment, the water circuit 43 is formed by drilling holes in the fixing base 31 and connecting channels of the holes. In other embodiments, the water circuit 43 can be integrally formed with the fixing base 31 to form water circuits of various shapes.

The bearing 33 is sleeved on the rotating shaft 52. The bearing 33 can ensure that the toaster body 1 can rotate at high speed smoothly, on the one hand, since the bearing 33 will generate friction with the rotating shaft 52, and the bearing 33 and the rotating shaft 52 are adjacent to or in contact with the heating assembly 2. On the other hand, since the fixing base 31 and the bearing 33 are made of metal material with good thermal conductivity, so that the fixing base 31 and the bearing 33 can work in a high-temperature working environment for a long time. Under this working environment, a life of the bearing 33 is limited, and it is easy to consume a lubricating oil prematurely, causing problems such as ball rusting, resulting in poor rotation and excessive torque of the toaster body 1, causing the bearing 33 to be easily damaged, affecting its service life, and further affecting the life of the toaster device 400. If the bearing 33 is damaged and cannot operate, the toaster device 400 needs to be replaced, so that the bearing 33 needs to be dissipated in time. By providing the water inlet 41, the water outlet 42, and the water circuit 43, the water circuit 43 is configured to water-cool the fixing base 31, which can take away a large amount of heat generated by working of the fixing base 31 and the bearing 33, and can prevent the bearing 33 from being damaged due to excessive temperature. At the same time, the water coming out of the water circuit 43 has absorbed a large amount of heat, and its temperature is increased. After entering the sugar generating chamber 12, the water can be converted into the water vapor without continuing to absorb a large amount of heat, and the sugar generating chamber 12 can recover the high temperature required for making cotton candy in time, so that it can ensure that the cotton candy machine keeps the humidity inside the sugar making chamber 200 stable while making high-quality cotton candy.

In a preferred embodiment, the humidifying assembly further includes a water storage chamber 45. The water storage chamber 45 is provided at the bottom of the sugar generating chamber 12, and is sleeved on the rotating shaft 52. The water delivery pipe 44 is in communication with the water storage chamber 45.

The water delivery pipe 44 delivers the water flowing out of the water circuit 43 into the water storage chamber 45, and absorbs heat in the water storage chamber 45 to form water vapor. The water vapor enters the sugar making chamber 12 under the centrifugal force generated by the high-speed rotating toaster body 1. As mentioned above, after the water absorbs heat in the water storage chamber 45, it becomes water vapor or fine water droplets and then enters the sugar generating chamber 12. The water vapor will not affect the viscosity of the syrup in the sugar generating chamber 12, nor will it cause the temperature of the sugar generating chamber 12 to drop suddenly so that the sugar grains cannot be fully melted into syrup, and will not affect the quality of the sugar syrup in the sugar generating chamber 12 or partially crack the sugar-making chamber 12, avoiding the problem of cracks caused by partial cooling of one side of the toaster body 1 for a long time. Since the water storage chamber 45 is sleeved on the rotating shaft 52, the rotating shaft 52 is located at a center of the water storage chamber 45, and the water storage chamber 45 will rotate with the rotation of the rotating shaft 52, that is, the water storage chamber 45 also rotates at a high speed, and the water or small water droplets or water vapor in the water storage chamber 45 undergoes centrifugal motion. At the same time, the water or small water droplets in the water storage chamber 45 are evenly sprinkled into the sugar generating chamber 12 under the action of centrifugal force, which can fully absorb heat, and the efficiency of converting into water vapor is high, which in turn results in a high utilization of water, low water consumption and almost no redundant waste water.

In a preferred embodiment, the humidifying assembly 4 further includes a water retaining element 46. The water retaining element 46 covers the water storage chamber 45, the feeding pipe 6 extends through the water retaining element 46 and is communication with the sugar generating chamber 12. Due to a retaining effect of the water retaining element 46, the water in the water storage chamber 45 will not easily enter the feeding pipe 6, so as to prevent the feeding pipe 6 from solidifying the sugar grains due to moisture.

Further, the water retaining element 46 is provided with a plurality of water outlet holes 461 extending through its thickness direction, the water outlet holes 461 are in communication with the water storage chamber 45 and the sugar generating chamber 12. The plurality of water outlet holes 461 are distributed around the rotating shaft 52 to form a circle. When the water storage chamber 45 rotates at a high speed, the water or small water droplets or water vapor moving centrifugally are thrown out of the sugar generating chamber 12 in the water outlet holes 461 away from a mouth of the feeding pipe 6.

In a preferred embodiment, the water outlet hole 461 is arranged in an outwardly inclined direction along a center of the water retaining element 46, that is, it is arranged radially, so that the water or small water droplets or water vapor in the water storage chamber 45 are easily thrown out. An inclination direction of the water outlet hole 461 is substantially the same as the direction of the centrifugal force of the water or small water droplets or water vapor in the water storage chamber 45 during high-speed rotation, so that the water or small water droplets or water vapor can be thrown out better and achieve a more efficient humidification effect.

In order to achieve a tight connection between the water retaining element 46 and the water storage chamber 45, an inner side surface of the water retaining element 46 is circumferentially provided with grooves 462 and an engaging portion 463 connected to edges of the grooves 462. Correspondingly, an engaging groove 451 is provided at a bottom of the water storage chamber 45, the engaging groove 451 can cooperate with the engaging portion 463 to achieve the connection between the water retaining element 46 and the water storage chamber 45. This type of connection is not easy to produce gaps at the connection between the two, and can prevent the water in the water storage chamber 45 from seeping out from the connection.

In connection with the previous description of the cotton candy machine, when the detecting unit detects that the humidity in the sugar making chamber 200 is too low, the controller 300 receives the signal from the detecting unit and sends an instruction to the water pump, and the humidification function is activated. The water is pumped out from the water tank by the water pump and enters the water circuit 43 through the water inlet 41. After absorbing a large amount of heat from the fixing base 31 and the bearing 33 in the water circuit 43, the water flows out from the water outlet 42. The heat-absorbed water becomes warm water or hot water, and then enters into the water storage chamber 45 from the water delivery pipe 44. The water storage chamber 45 is in a state of high-speed operation, the warm water or hot water injected by the water delivery pipe 44 is evenly sprayed on an inner wall of the groove 462 of the water retaining element 46 to absorb the heat of the water retaining element 46, further warming up the warm water or hot water into water vapor or small water droplets. Under the action of centrifugal force, the water vapor or small water droplets are evenly thrown out from the water outlet hole 461, and thrown into the sugar generating chamber 12, and further absorb heat in the sugar generating chamber 12 to become water vapor, which is thrown out into the sugar making chamber 200 through the tooth opening or the through hole 131, and then plays a humidification effect, so that the cotton candy machine can work in an optimal humidity environment.

The machine base 3 further includes a support post 35, the support post 35 is provided between the fixing base 31 and the support plate 34 to form the accommodating space (not labeled). A collector ring 36, a carbon brush 37, and a thermocouple (not shown) are provided in the accommodating space.

Specifically, the collector ring 36 is fixed on the rotating shaft 52, the carbon brush 37 is connected to the collector ring 36, the thermocouple is configured to detect a temperature of the heating assembly 2. The thermocouple transmits a detected temperature signal to the collector ring 36, and the collector ring 36 transmits the signal to the controller 300. This signal transmission method can accurately transmit the signal, greatly simplifies a structure of the system, and avoids possible damage to wires during rotation. The thermocouple detects the temperature of the heating assembly 2, which can prevent the sugar grains from being scorched due to excessive temperature, or a phenomenon of sugar blocking caused by too low temperature, so as to ensure a smooth formation of sugar filaments and a smooth progress of the cotton candy production process.

In addition, an outer side of the motor assembly 5 and an outer side of the accommodating space are provided with protecting cases 56 to protect inner components from external damage or dust.

The foregoing descriptions are merely specific embodiments of the present disclosure, but are not intended to limit the protection scope of the present disclosure. Any variation or replacement readily figured out by a person skilled in the art within the technical scope disclosed in the present disclosure shall all fall within the protection scope of the present disclosure.

1. A toaster device for making cotton candy, comprising a toaster body, a heating assembly, a machine base, a humidifying assembly, a motor assembly, and a feeding pipe;
wherein the toaster body is provided with a sugar generating chamber, the heating assembly is provided blow the toaster body;
the machine base comprises a fixing base, a though hole, a bearing, and a support plate, the though hole penetrates through upper and lower sides of the fixing base, the bearing is located in the though hole, the motor assembly comprises a motor and a hollow rotating shaft, the motor and the rotating shaft are provided on upper and lower sides of the support plate, respectively, the rotating shaft sequentially extends through the fixing base and the heating assembly, a top end of the rotating shaft is fixed to the toaster body, the motor is configured to drive the rotating shaft to drive the toaster body to rotate, the feeding pipe extends through the rotating shaft into the toaster body and is in communication with the sugar generating chamber;
the humidifying assembly comprises a water inlet, a water outlet, a water circuit, and a water delivery pipe, the water inlet and the water outlet are provided on the fixing base, the water circuit is provided inside the fixing base and arranged around the though hole, one end of the water circuit is in communication with the water inlet, the other end thereof is in communication with the water outlet, one end of the water delivery pipe is in communication with the water outlet, and the other end thereof is in communication with the sugar generating chamber through the feeding pipe.

2. The toaster device according to claim 1, wherein the humidifying assembly further comprises a water storage chamber provided at a bottom of the sugar generating chamber, the water storage chamber is sleeved on the rotating shaft, and the water delivery pipe is in communication with the water storage chamber.

3. The toaster device according to claim 2, wherein the humidifying assembly further comprises a water retaining element covering the water storage chamber, and the feeding pipe extends through the water retaining element and is in communication with the sugar generating chamber.

4. The toaster device according to claim 3, wherein the water retaining element is circumferentially provided with a plurality of water outlet holes, the water outlet holes are in communication with the water storage chamber and the sugar generating chamber.

5. The toaster device according to claim 3, wherein an inner side of the water retaining element is circumferentially provided with grooves and an engaging portion connected to edges of the grooves, an engaging groove is provided at a bottom of the water storage chamber, the engaging groove cooperates with the engaging portion to achieve a connection between the water retaining element and the water storage chamber.

6. The toaster device according to claim 4, wherein the water outlet hole is arranged in an a direction along a center of the water retaining element.

7. The toaster device according to claim 1, further comprising a thermocouple, a collector ring, and a carbon brush, wherein the machine base further comprises a support post provided between the fixing base and the support plate to form an accommodating space, the collector ring, the carbon brush, and the thermocouple are provided in the accommodating space.

8. The toaster device according to claim 1, further comprising a temperature measuring sensor provided at the toaster body.

9. A steam humidifying type cotton candy machine, comprising a detecting unit, a sugar making chamber, a controller, and the toaster device for making cotton candy according to claim 1, wherein the detecting unit is configured to detect a humidity in the sugar making chamber, the controller is electrically connected to the detecting unit and the toaster device respectively, the controller receives a signal sent by the detecting unit and generates a corresponding control humidity instruction and output the instruction to the humidifying assembly of the toaster device, and the humidifying assembly is adjusted accordingly to adjust the humidity in the sugar making chamber.

10. The cotton candy machine according to claim 9, further comprising a housing, a sugar taking space, a manipulator, and a stick dispensing device, wherein the sugar making chamber is formed in the housing, the sugar taking space is provided on the housing, the controller and the toaster device are both provided in the housing, the manipulator and a stick dispensing device are both provided in the sugar making chamber, the manipulator is configured to grip a sugar stick in the stick dispensing device and wind sugar filament above the toaster device to make a cotton candy.

11. The toaster device according to claim 1, further comprising a temperature measuring sensor provided between the heating assembly and the toaster body.

12. A toaster device for making cotton candy, comprising a toaster body, a heating assembly, a machine base, a humidifying assembly, a motor assembly, and a feeding pipe;
wherein the toaster body is provided with a sugar generating chamber, the heating assembly is provided blow the toaster body;
the machine base comprises a fixing base, a though hole, a bearing, and a support plate, the though hole penetrates through upper and lower sides of the fixing base, the bearing is located in the though hole, the motor assembly comprises a motor and a hollow rotating shaft, the motor and the rotating shaft are provided on upper and lower sides of the support plate, respectively, the rotating shaft sequentially extends through the fixing base and the heating assembly, a top end of the rotating shaft is fixed to the toaster body, the motor is configured to drive the rotating shaft to drive the toaster body to rotate, the feeding pipe extends through the rotating shaft into the toaster body and is in communication with the sugar generating chamber;
the humidifying assembly is configured to humidify an interior of the sugar generating chamber.

13. The toaster device according to claim 12, wherein the humidifying assembly comprises a water delivery pipe extending to the interior of the sugar generating chamber, the water delivery pipe is configured to deliver humidifying liquid into the sugar generating chamber to humidify the interior of the sugar generating chamber.

14. The toaster device according to claim 12, wherein the interior of sugar generating chamber is provided with a water storage chamber, the humidifying assembly is configured to deliver humidifying liquid into the water storage chamber to humidify the interior of the sugar generating chamber.

15. A humidifying assembly for a toaster device for making cotton candy comprising a sugar generating chamber, a fixing base provided with a though hole, and a feeding pipe, comprising:
a water inlet provided on the fixing base;
a water outlet provided on the fixing base;
a water circuit provided inside the fixing base and arranged around the though hole, one end of the water circuit being in communication with the water inlet, the other end thereof being in communication with the water outlet; and
a water delivery pipe, one end of the water delivery pipe being in communication with the water outlet, and the other end thereof being in communication with the sugar generating chamber through the feeding pipe.

16. The humidifying assembly according to claim 15, further comprising a water storage chamber provided at a bottom of the sugar generating chamber, wherein the toaster device further comprises a motor assembly, the water storage chamber is sleeved on a rotating shaft of the motor assembly, and the water delivery pipe is in communication with the water storage chamber.

17. The humidifying assembly according to claim 16, further comprising a water retaining element covering the water storage chamber, wherein the feeding pipe extends through the water retaining element and is in communication with the sugar generating chamber.

18. The humidifying assembly according to claim 17, wherein the water retaining element is circumferentially provided with a plurality of water outlet holes extending through a thickness direction thereof, the water outlet holes are in communication with the water storage chamber and the sugar generating chamber.

19. The humidifying assembly according to claim 17, wherein an inner side of the water retaining element is circumferentially provided with grooves and an engaging portion connected to edges of the grooves, an engaging groove is provided at a bottom of the water storage chamber, the engaging groove cooperates with the engaging portion to achieve a connection between the water retaining element and the water storage chamber.

20. The humidifying assembly according to claim 18, wherein the water outlet hole is arranged in an outwardly inclined direction along a center of the water retaining element.
